(19) United States
(12) Patent Application Publication
(10) Pub. No.: US 2002/0134723 A1
(43) Pub. Date: Sep. 26, 2002

(54) Fluid filtration apparatus

(76) Inventors: Gerald F. Smith, Watertown, MN (US); Loran W. Sutton, East Peoria, IL (US); Gary F. Krofchalk, Rockwall, TX (US)

Correspondence Address: Michael S. Bush, Bush Patent & Law Group, Suite K - PMB 139, 6850 North Shiloh Road, Garland, TX, 75044, US

(21) Appl. No.: 09/818,989

(22) Filed: Mar. 26, 2001

(51) Int. Cl. B01D 35/00

(52) U.S. Cl. 210/299; 210/435

(57) ABSTRACT

A fluid filtration apparatus includes a housing structure having an internal flow path through which a fluid to be filtered may be flowed, a filtration structure operably interposed in the internal flow path and a liner element disposed between an interior side surface of a side wall of the housing structure and the filtration structure operably interposed in the internal flow path.

CROSS-REFERENCE TO RELATED APPLICATION

This application is a Continuation-In-Part of U.S. patent application Ser. No. 09/ ______ (Atty. Docket No. PVORT-0001), entitled “Fluid Filtration Apparatus”, filed on Mar. 22, 2001, and hereby incorporated by reference as if reproduced in its entirety.

### TECHNICAL FIELD

This specification relates generally to fluid filtration apparatus and, more particularly, to a fluid filtration apparatus having full flow and bypass flow portions commonly residing within a lined canister element.

### BACKGROUND

A fluid is a substance, most commonly, a liquid or a gas, capable of flowing within a defined system and/or conforming to the outline of a container in which it is stored. A system or other device within which one or more fluids flows along an expected fluid flow path often includes a fluid filtration apparatus positioned along the expected fluid flow path such that the fluid will flow through the fuel filtration apparatus. For example, fluid filters are often used in various automotive vehicle engine applications to remove contaminants from fluids flowing within the engine, for example, the engine oil currently used to lubricate bearings and reduce friction in automotive vehicle engines. Thus, while the present specification is directed to an application of the disclosed fluid filtration apparatus within an automotive vehicle engine, it should be clearly understood that the described application is purely exemplary and that the disclosed fluid filtration apparatus is equally suitable for use in conjunction with other applications which may also benefit from incorporation of one or more fluid filters along a fluid flow path thereof Such further applications include, but are not necessarily limited to, vehicle engine applications other than those specifically recited herein; non-engine vehicle applications, for example, fuel delivery systems; and non-vehicle engine applications, for example, turbine engine applications; as well as any other application not specifically recited herein but characterized by a fluid flow within a defined area for which removal of contaminants or other particulate matter is desired.

In the aforementioned automotive vehicle engine application, lubricating oil is circulated through the engine and carries contaminants such as metal particles, carbon particles and dirt which may cause harm to the engine. In order to effectively lubricate the engine, engine oil is passed through a filter to remove the contaminants before the oil is recirculated into the engine. The typical oil filter is attached to an internal combustion engine at an oil filter receptacle portion thereof. Engine oil passes through a discharge opening in the oil filter receptacle, into a fluid filter, and then into the engine lubrication system through an oil inlet pipe. A filter element in the fluid filter removes contaminants from the oil before it reenters the engine through the oil inlet pipe. Oil filters for gasoline and diesel engines have traditionally been of the “full flow” type in which engine-generated oil pressure is utilized to flow all of the oil discharged from the engine through a filtration element in the overall filter structure before returning the oil to the engine.

While this full flow type of oil filter structure is widely used, and generally suited for its intended purpose, it is subject to a variety of well known problems, limitations and disadvantages. For example, this type of full flow filtration structure is normally suited for removal of relatively large size contaminants—namely, particles of a 40 micron size and larger. Smaller contaminants, such as soot particles generated by diesel engines, simply pass through the filter element and are permitted to be returned to the engine. Another disadvantage of conventional full flow oil filters is that since all of the oil discharged from the engine is flowed through the filtration element, such element has a relatively limited duty cycle before it becomes clogged and must be replaced (if the filtration element is of a disposable type) or cleaned (if the filtration element is of a cleanable, reuseable type).

The useful life of a full flow filter assembly may be extended by increasing the effective area of its filtration element, such as by providing the element with a pleated configuration. However, this adds considerably to the cost of the element, makes it a great deal thicker, and substantially increases the difficulty in cleaning the element if it is of the reuseable type.

Another approach to extending the duty cycle of a full flow type filter assembly is illustrated and described in U.S. Pat. No. 5,569,373 to Smith et al. which is hereby incorporated by reference as if reproduced in its entirety. In the full flow type filter assembly disclosed therein, oil forced from the engine into an outer tubular canister portion of the filter assembly is directed through axially and circumferentially angled inlet openings disposed radially outwardly of a tubular full flow filtration element coaxially disposed within the canister. The angulated orientation of these inlet openings causes the oil discharged into the canister to swirl in a vortex pattern outwardly around the filtration element, with the result that contaminants or other types of particulate matter are forced outwardly away from the outer side surface of the filtration element.

Due to this vortex-created centrifuge action imparted to the incoming contaminant or other particulate-bearing oil, partially purified oil is forced through the filtration element and then returned via the interior of the element to the engine. Particulate matter forced outwardly toward the inner side surface of the canister, and thus prevented from flowing inwardly through the full flow filter element, falls by gravity into a lower contaminant chamber of the filter assembly.

While the duty cycle of the vortex-based full flow oil filter assembly illustrated and described in U.S. Pat. No. 5,569,373 is substantially increased compared to full flow oil filter assemblies of more traditional constructions, the filter assembly is still relatively ineffective in filtering out sub-40 micron size particles such as soot particles created in abundance by diesel engines. These small contaminant particles, for the most part, simply pass through the filter element and are returned to the engine.

One conventional method of solving this problem of being unable to effectively filter out small (for example, the aforementioned sub-40 micron size) contaminants or other types of particulate matter with a full flow filter is to augment the full flow filter with a filtration structure commonly referred to as a bypass filter structure. This bypass filter structure has a filtration element sized to trap the small contaminant particles that the full flow filtration assembly cannot separate from the oil, and is connected in parallel with the full flow assembly. The bypass filter structure is mounted remote from the full flow filtration structure and is connected thereto by appropriate hoses. Oil discharged from the engine during operation thereof is routed separately to the full flow and bypass flow filtration structures, with only a small portion of the discharged oil (i.e., less than ten percent in most cases) being flowed through the bypass filtration structure. In this manner, large and small contaminants or other types of particulate matter are separately handled.

As conventionally practiced, this dual filtration structure approach has a variety of problems, limitations and disadvantages. For example, it substantially adds to the cost and complexity of the overall filtration system and makes it more difficult and time consuming to maintain. Additionally, the necessity of using hoses connected to the filtration apparatus substantially increases the possibility that leaks will develop in the system due to, for example, vibration stresses being imposed for long periods on the hoses and their fittings. Furthermore, since two separate filtration systems must be employed under this scheme, more space must be dedicated to the filtration system.

Due to the aforementioned limitations, in U.S. patent application Ser. No. 09/ ______ (Atty. Docket No. PVORT-0001), we disclosed a fluid filtration apparatus which provides the benefits of both full flow and bypass flow types of filtration structures while at the same time eliminating or at least substantially reducing the above-mentioned problems, limitations and disadvantages commonly associated with auxiliary bypass flow filtration structures. Specifically, in the aforementioned application, a fluid filtration apparatus in which both the full flow and bypass flow portions of a fluid filtration apparatus are housed within a single canister element was disclosed. To house both the full flow and bypass flow portions within the aforementioned single canister element, the bypass flow portion of the fluid filtration apparatus was nested within the full flow portion thereof, for example, by arranging the full flow filtration structure in a first generally tubular configuration and arranging the bypass filtration structure in a second generally tubular configuration coaxially nested within the full flow filtration structure. The fluid filtration apparatus further included an adapter structure for imparting a swirling flow pattern centered about the full flow filtration structure to fluid entering the canister element. As the bypass filtration structure was configured to include a filtering portion and a spaced series of discharge openings arranged such that the unfiltered discharge of a first portion of the fluid flowing through the bypass filter structure created a lowered pressure area within the filtering portion of the bypass filter structure, a second portion of the fluid flowing through the bypass filter structure was drawn through the filtering portion of the bypass filter structure.

While satisfactory for the uses contemplated therein, it is noted that a fluid filtration apparatus in which the bypass filtration structure is nested within the full flow filtration structure is subject to clogging of the filtering portion of the bypass filter structure, particularly when such a fluid filtration apparatus is utilized, within a diesel engine, as an oil filter for diesel engine lubrication oil. More specifically, it is commonly known that diesel engines generate soot which accumulates in the diesel engine lubrication oil in significant quantities. As soot particles tend to agglomerate or otherwise combine into larger particles, the agglomerated soot particles tend to more quickly clog the filtering portion of the bypass filter structure. Furthermore, such particles are more likely to form a sludge capable of damaging the diesel engine. As a result, the length of time during which the bypass filter structure may be operated without need of replacing or cleaning the filtering portion thereof is reduced.

Thus, while all of the different types of fluid filtration apparatus described herein remove contaminants and other types of particulate matter from fluids flowing through the variously configured filter structures residing within a canister housing the filter structure, all could achieve enhanced performance if reconfigured such that the fluid entering the canister is placed in contact with a supplemental liner element disposed between an interior side surface of the canister sidewall and the various filter structures residing within the canister housing. It is, therefore, an object of the invention to provide such an enhanced fluid filtration apparatus.

### SUMMARY

A fluid filtration apparatus includes a housing structure having an internal flow path through which a fluid to be filtered may be flowed, a filtration structure operably interposed in the internal flow path and a liner element disposed between an interior side surface of a side wall of the housing structure and the filtration structure operably interposed in the internal flow path.

### BRIEF DESCRIPTION OF THE DRAWINGS

FIG. 1 is a partially cut away and exploded perspective view of a fluid filtration apparatus having full flow and bypass flow portions thereof commonly residing within a lined canister element.

FIG. 2 is a first horizontally directed cross-sectional view, partly in elevation, through a portion of the fluid filtration apparatus of FIG. 1 and illustrating a first embodiment of the lined canister element thereof.

FIG. 3 is a second horizontally directed cross-sectional view, partly in elevation, through a portion of the fluid filtration apparatus of FIG. 1 and illustrating a second embodiment of the lined canister element thereof.

FIG. 4 is a third horizontally directed cross-sectional view, partly in elevation, through a portion of the fluid filtration apparatus of FIG. 1 and illustrating a flow path for a fluid flowing through the full flow portion thereof.

FIG. 5 is a simplified, horizontally directed cross-sectional view through a portion of the fluid filtration apparatus of FIG. 1, with a full flow filtration screen section thereof being shown in phantom for purposes of illustrative clarity and illustrating a flow path for a fluid flowing through the full flow and bypass flow portions thereof.

FIG. 6 is a simplified, somewhat schematic, enlarged scale side elevational view of a bypass filtration portion of the fuel filtration apparatus of FIG. 1, the bypass filtration portion being longitudinally foreshortened.

### DETAILED DESCRIPTION

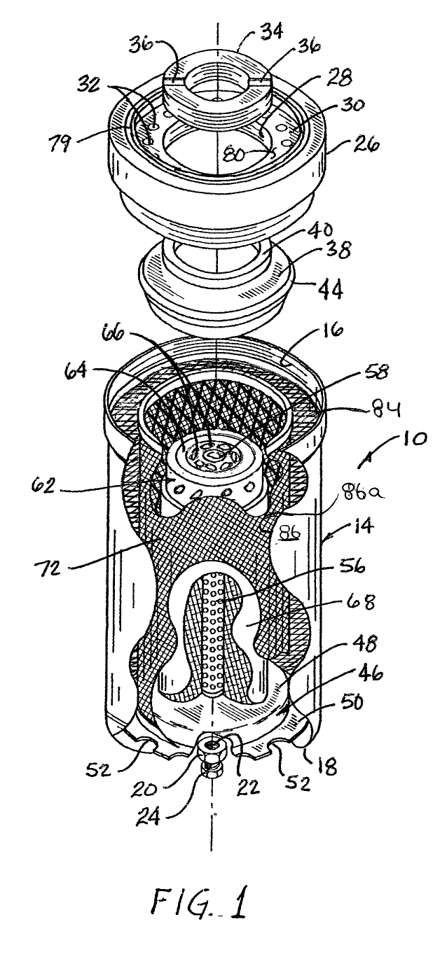

Referring first to FIGS. 1 and 4-5, the present invention provides a specially designed fluid filtration apparatus 10, for example, an oil filter assembly, which is operatively connectable, in a subsequently described manner, to a system 12, for example, an engine block of a gasoline or diesel engine, in which a fluid, for example, a liquid or gas, flows along an expected fluid flow path, thereby enabling the fuel filtration apparatus 10 to remove contaminants or other types of particulate matter from the fluid. Of course, while the fuel filtration apparatus 10 disclosed herein is embodied within an engine application, specifically, an engine block of an engine, it will be readily appreciated by those of ordinary skill in the filtration art that the fluid filtration apparatus 10 is suitable for use within wide variety of other applications, including non-engine applications, for example, transmission or hydraulic systems, as well as a wide variety of other applications generally characterized by a flow of a contaminant or other particulate matter-bearing fluid to be filtered.

The fluid filtration apparatus 10 includes a hollow cylindrical outer canister or housing 14 having an open, internally threaded upper end 16, and a closed lower end 18 from which an integral, generally nut-shaped drain projection 20 centrally depends. The internally threaded opening 22 of the projection 20 defines a bottom drain opening of the canister 14. A generally bolt-shaped drain plug 24 is removably threaded into the opening 22 to close it.

An annular adapter head member 26 is threaded into the open upper end 16 of the canister 14 and has a central, internally threaded circular opening 28 extending axially therethrough. Opening 28 is circumscribed by an annular, inwardly projecting flange 30 through which a circumferentially spaced series of angled inlet openings 32 extend. The inlet openings 32 are sloped axially and circumferentially relative to the axis of the adapter head 26 in a manner such that, as subsequently described herein, when oil is forced downwardly through the openings 32 it swirls in a vortex flow pattern about the longitudinal axis of the canister 14.

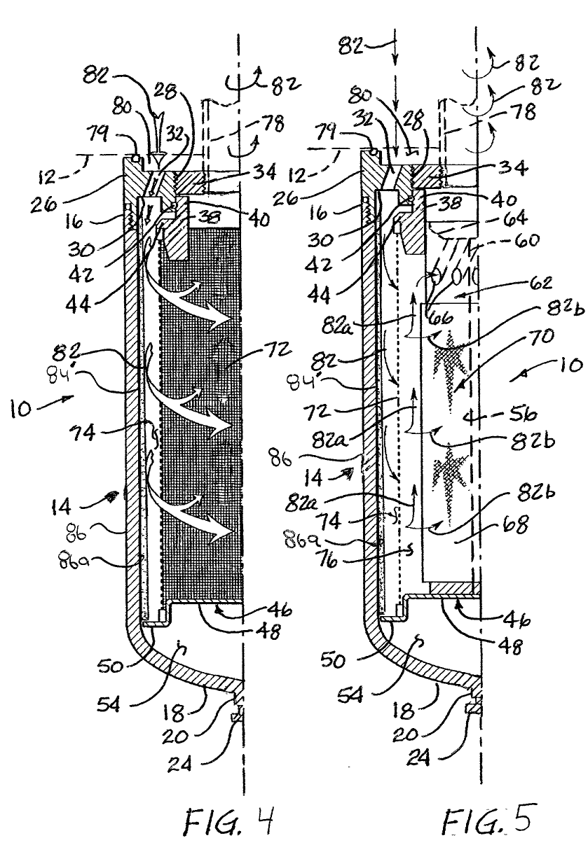

An internally and externally threaded adapter ring 34 is threaded into the adapter head member opening 28 and has diametrically opposite, radially extending driving slots 36 formed in its top side surface to facilitate this connection. Directly below the adapter head 26 is an annular top screen fixture 38 having an annular top side flange 40 that is telescopingly received in the adapter head 26 and sealed therein by means of a suitable seal member 42 (See FIG. 4), for example, an O-ring. Top screen fixture 38, which could alternatively be formed integrally with the adapter head 26 if desired, projects downwardly through the upper end 16 of the canister 14 and has an axially intermediate annular exterior peripheral flange 44.

Removably received in a bottom interior end portion of the canister 14 is a circular bottom screen fixture 46 having a raised central circular portion 48, and a bottom side annular peripheral flange 50 having a circumferentially spaced series of radially inwardly extending peripheral notches 52 formed therein. The engagement of the outer periphery of the flange 50 with a downwardly and radially sloping lower end portion of a side wall 86 of the canister 14 supports the bottom screen fixture 46 above the drain opening 22, with the bottom screen fixture 46 forming a top side wall of a contaminant chamber 54 in a lower interior end portion of the canister 14.

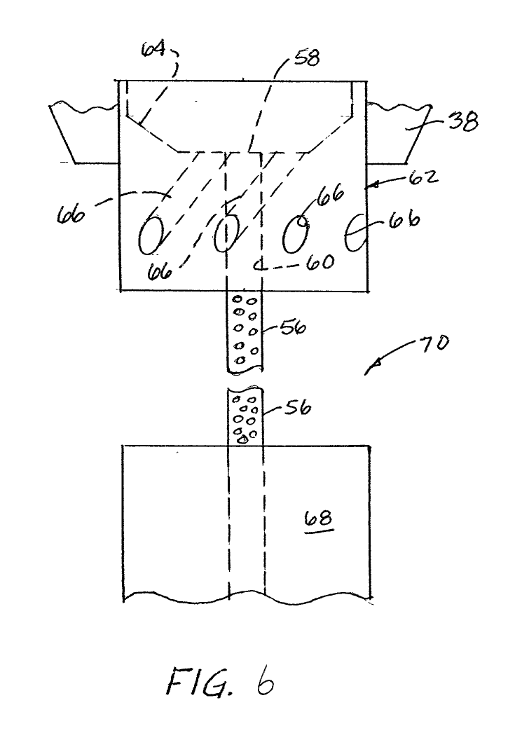

Longitudinally extending upwardly from a central top side portion of the raised central portion 48 of the bottom screen fixture 46, and suitably anchored thereto or formed integrally therewith, is a perforated flow tube 56 having an open upper end 58. An upper end portion of the tube 56 is slidably and removably received in the central opening 60 of a tubular bypass head member 62 (see FIG. 6 also) which, in turn, is removably received within the annular top screen fixture 38 as best illustrated in FIG. 5. Alternatively, the bypass head member 62 may be formed integrally with the overlying top screen fixture 38 if desired.

With reference now to FIGS. 1, 5 and 6, the upper end of the bypass head member 62 has a sloping, axially inset central portion 64 which, at its bottom side, meets the central opening 60 of the bypass head member 62 that removably receives an upper end portion of the perforated tube 56. Extending between a vertical side wall portion of the bypass head member 62 and the sloping inset central portion 64 are a circumferentially spaced series of angled discharge openings 66 which, relative to the axis of the tubular bypass head member 62, are axially and circumferentially sloped in a manner such that, as subsequently described herein, fluid discharged from the bypass head member 62 swirls in a vortex pattern about the axis of the bypass head member 62. Alternatively, the discharge openings 66 may extend axially through the bypass head member 62 so that no appreciable swirl is imparted to oil exiting the discharge openings 66.

Circumscribing the perforated flow tube 56, and axially extending between the top side of the raised central portion 48 of the bottom screen fixture 46 and the lower end of the tubular bypass head member 62 is a replaceable tubular bypass filter element 68. Replaceable filter element 68, which is operative to filter out relatively small contaminant particles (i.e., sub 40 micron size particles) from fluid operatively traversing the fluid filter apparatus 10 as later described herein, is representatively of a wound fabric construction, but could alternatively be of other constructions, such as a foam filtration material, if desired. Together, the perforated flow tube 56, the bypass head member 62 and the replaceable bypass filter element 68 form a uniquely operative bypass filter section 70 of the overall fluid filter apparatus 10. Of course, in an alternate configuration thereof, the replaceable tubular bypass filter element 68 may instead be constructed as a disposable filter element.

In addition to the bypass filter section 70, the fluid filter apparatus 10 also includes a full flow filtration section which is representatively defined by a tubular, reuseable and cleanable full flow filter element 72 which, as later described herein, is traversed by all of the fluid flowing through the fluid filter assembly 10. Full flow filter element 72 is representatively of a wire mesh construction and is operative to filter out from the oil relatively large contaminant particles (i.e., particles of about 40 micron size and above). Of course, in an alternate configuration thereof, the fill flow filter element 72 may instead be constructed as a disposable filter element.

As best illustrated in FIGS. 4 and 5, the full flow filter element 72 is coaxially and removably received within the canister 14 and coaxially and outwardly circumscribes the bypass filter section 70. The raised central portion 48 of the bottom screen fixture 46 is telescopingly and supportingly received in a lower end portion of the full flow filter element 72, and a bottom annular side portion of the top screen fixture 38, below its peripheral flange 44, is telescopingly and supportingly received in a top end portion of the full flow filter element 72. As best illustrated in FIG. 5, the installed full flow filter element 72 forms, within the canister 14, an annular outer flow area 74 and an annular inner flow area 76. Of these, the annular outer flow area 74 circumscribes the axis of the canister 14 and is disposed between the vertical interior side surface of the canister 14 and the full flow filter element 72 while the annular inner flow area 76 circumscribes the bypass filter section 70 and is disposed between the full flow filter element 72 and the bypass filter section 70. The upper end of the annular outer flow area 74 underlies the angled inlet openings 32, and the downwardly dished upper end of the bypass head member 62 underlies the central opening in the adapter ring 34.

As shown in FIGS. 4 and 5, the fluid filter assembly 10, for example, an oil filter, is installed on the system 12, for example, an engine block 12, by simply rotating the fluid filter assembly 10 relative to the system 12 in a manner causing an externally threaded fluid filter stub portion 78 of the system 12 to thread into the adapter ring 34 and causing an O-ring seal 79, carried in an annular groove in the top peripheral side portion of the adapter head 26, to be sealingly compressed against the system 12 to seal off an axially inset portion 80 of the top side of the adapter head 26 positioned above its annular flange 30 and communicating with unfiltered fuel discharge ports (not shown) in the system block 12.

The unique operation of the installed fluid filter assembly 10 will now be described in conjunction with FIGS. 4 and 5. During operation of the system 12 with which the fluid filter assembly 10 is associated, the fluid 82 discharged from the system 12 during operation thereof is forced downwardly through the angled adapter head member inlet openings 32 and into the annular outer flow area 74 and is caused to swirl therein about the full flow filter element 72. This swirling or “vortex” flow pattern imparted to the fluid 82 within the flow area 74 causes, by centrifugal force, contaminant or other particulate matter in the fluid to be forced outwardly toward the vertical interior surface of the canister 14 (while partially purified fluid 82 is forced inwardly through the full flow filter element 72 into the inner annular flow area 76) thereby permitting the contaminant or other particulate matter to settle downwardly into the contaminant chamber 54 via the peripheral notches 52 in the bottom side flange 50.

As illustrated in FIG. 5, a major portion 82a of the fuel 82 entering the inner annular flow area 76 through the full flow filter element 72 (representatively 90 percent or more of such fluid) is forced into and upwardly through the angled bypass head member discharge openings 66. The fluid portion 82a upwardly exiting these angled discharge openings 66, around the upper end of the central bypass head opening 60, is caused to swirl about the axis of the bypass head 62 in a swirling flow pattern which creates a low pressure area similar to a tornado vacuum. This swirling flow pattern imparted to the fluid portion 82a creates a venturi effect within the inset top portion 64 of the bypass head 62 which, in turn, creates a lowered pressure region adjacent the top end of the central opening 60.

Such lowered pressure region in the inset portion 64 operates to draw the remaining fluid portion 82b within the inner annular flow area 76 laterally through the bypass filter element 70 (thereby filtering out sub-40 micron size contaminant or other particulate matter through the interior of the perforated tube 56, and then into the inset area 64 where the fluid portion 82b joins the swirling fluid portion 82a and is carried along therewith for discharge from the fluid filter assembly 10 and return to the system 12 via the fluid filter stub 78.

As can be readily seen, the fluid filter assembly 10 functions, in a single compact package, as both a full flow filter and a bypass filter, with the bypass filter portion of the overall assembly being representatively nested within its full flow filtration portion. There are no tubes required for the installation of a fluid filtration system which incorporates the fluid filtration apparatus 10, only one external filtration device needs to be installed on the system 12, and the separate fall flow and bypass filtration sections are firmly supported within the canister 14 against possible vibration damage and resulting leakage. Representatively, the full flow and bypass filtration sections are arranged in series, with the fluid 82 flowing first through the full flow filtration portion 72, and then flowing through the bypass filtration section 70.

By virtue of the incorporation of both full flow and bypass filtration sections in the fluid filter assembly 10, the fluid filter assembly 10 is provided with a substantially lengthened duty cycle since it is able to filter out from the fluid circulated therethrough both 40+and sub-40 micron sized contaminant or other particulate matter. The compact and quite simple fluid filter assembly 10 desirably provides the added benefit of fine particle bypass filtration without most of the disadvantages of conventional separate bypass filtration systems.

Referring now to FIGS. 5 and 6, after a duty cycle of the fluid filter assembly 10 comes to an end, the fluid filter assembly 10 may be easily and quickly readied for another duty cycle as follows. With the system 12 turned off, the drain plug 24 is removed, and the fluid in the canister 14 drained therefrom. The canister 14 is then unscrewed and removed from the adapter head member 26 to expose the full and bypass filtration sections 72,70. The full flow filter element 72 is then removed from the canister 14, the upper end of the perforated tube 56 is removed from the bypass head 62, the bypass filter element 68 is upwardly removed from the tube 56 and discarded, and the reuseable filter element 72 is appropriately cleaned. A replacement bypass filter element 68 is installed on the tube 56, the tube 56 is reconnected to the bypass head 62, and the cleaned full flow filter element 72 is placed back in the canister 14. The canister 14 is then screwed back onto the adapter head member 26 as shown in FIGS. 4 and 5 to ready the fluid filter assembly 10 for another duty cycle.

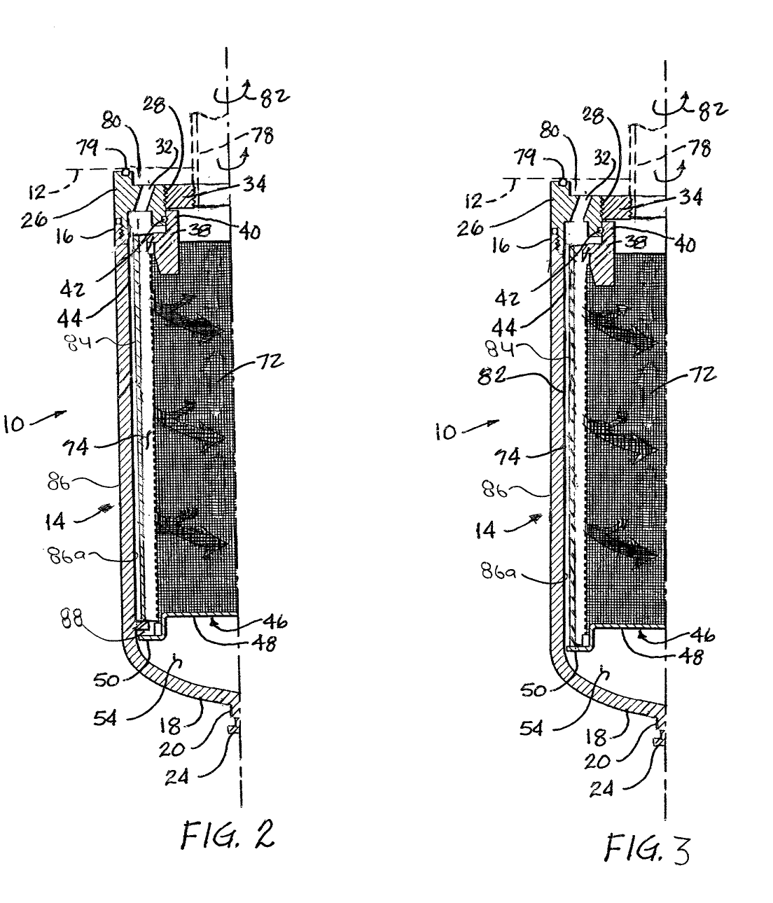

Referring now to FIGS. 2-5 collectively, various embodiments of the fluid filtration apparatus 10 configured to remove increased amounts of contaminants or other particulate matter before such matter is captured by a filter structure disposed within the interior of the canister 14 will now be described in greater detail. While the foregoing description of the invention is primarily described with respect to one particular embodiment of the invention, specifically, that embodiment in which the filter structure is comprised of nested bypass and full flow filter structures positioned within the canister 14 equipped with a liner element 84, it should be clearly understood that it is fully contemplated that the disclosed liner element 84 is equally suitable for use with a wide variety of fluid filtration apparatus, including, but not limited to those specifically described herein, in which a filter structure is positioned in the interior of the canister 14.

Turning now to the embodiment of the invention in which the filter structure is comprised of nested bypass and full flow filter structures, the replaceable (or, alternately, disposable) bypass filter element 68 will now be described in greater detail. More specifically, in FIG. 2, the fluid filtration apparatus 10 includes a liner element 84 arranged around at least a portion of an interior side surface 86a of the side wall 86 of the canister 14 to enhance the amount of contaminants or other particulate matter which may be removed, by the fluid filtration apparatus 10, from the fluid flowing therethrough without clogging the bypass filter element 68 or otherwise reducing the rate at which fluid may flow through the fluid filtration apparatus 10.

To achieve this objective, the liner element 84 must provide a surface to which contaminants or other particulate matter contained in a fluid flowing through the fluid filtration apparatus 10 will either readily adhere or otherwise cling thereto or be trapped thereby. Thus, it is fully contemplated that the liner element 84 may be variously configured while maintaining suitability for the uses contemplated herein. Generally speaking, the liner element 84 should be configured to include an irregular surface capable of facilitating, and thereby taking advantage of, the agglomeration feature of soot particles or other contaminants and/or particulate matter. By doing so, the liner element 84 may enhance the capture of such agglomerating particles thereby.

For example, one suitable configuration for the liner element 84 is illustrated in FIGS. 1-3. Here, the liner element 84 is configured as a generally cylindrical element which is installed within the canister 14 by simply inserting the generally cylindrical liner element 84 within the annular outer flow area 74. Once inserted within the annular outer flow area 74, typically, at a selected location either adjacent to, or spaced apart a small distance apart from, the interior side surface 86a of the side wall 86, the generally cylindrical liner element 84 will provide a surface which, depending on the particular physical configuration of the generally cylindrical liner element 84, will tend to trap or otherwise encourage the adherence of contaminants or other particulate matter to the generally cylindrical liner element 84. If the generally cylindrical liner element 84 is spaced apart from the interior side surface 86a, the generally cylindrical liner element 84 is most commonly constructed of a woven or expanded metal screen held in place a small distance from the interior side surface 86a of the side wall 86, typically, on the order of a fraction of an inch, by a support structure comprised of one or more relatively small support beams. Conversely, if the generally cylindrical liner element 84 is engagingly fitted against the interior side surface 86a of the side wall 86, the generally cylindrical liner element 84 is most commonly constructed to have a depth somewhat greater than when the generally cylindrical liner element 84 is spaced apart from the interior side surface 86a of the side wall 86.

It is further contemplated that, in addition to the woven or expanded metal screens hereinbefore disclosed, a wide variety of other materials are equally suitable for use as the generally cylindrical liner element 84. For example, it is fully contemplated that cellular foam or woven synthetic materials are equally suitable for the uses contemplated herein whenever such alternate materials have a retention characteristic sufficiently high to remove the desired amounts of contaminants or other particulate matter from the fluid. Furthermore, it is specifically contemplated that the generally cylindrical liner element 84 may be alternately constructed of either a cleanable and reusable material or a disposable material similar to the cleanable and reusable and disposable materials hereinbefore described.

In still other alternate configurations thereof, it is contemplated that, when inserted within the canister 14, the generally cylindrical liner element 84 may either be supported, within the annular outer flow area 74, by either the bottom screen fixture 46 or the canister 14 itself. In FIG. 2, the generally cylindrical liner element 84 is supported, within the annular outer flow area 74, by a ledge 88, circumferentially extending along the interior side surface 86a of the side wall 86 at an generally orthogonal angle thereto. In FIG. 3, on the other hand, the generally cylindrical liner element 84 is supported, within the annular outer flow area 74, by the bottom side annular peripheral flange 50.

It is further contemplated that, rather than being supported by either the circumferential ledge 88 of the side wall 86 or the bottom side annular peripheral flange 50 of the bottom screen fixture 46, the generally cylindrical liner element 84 may instead be fixedly attached, for example, using a welding process, to either of these supporting members. While such alternate configurations thereof would not differ substantially in appearance from those configurations respectively illustrated in FIGS. 2 and 3, the permanent affixation of the generally cylindrical liner element 84 to either one of the circumferential ledge 88 or the bottom side annular peripheral flange 50 would modify the process by which the generally cylindrical liner element 84 would be removed for either replacement or cleaning in preparation for reuse thereof. Specifically, rather than allowing the generally cylindrical liner element to be separately replaced or removed for cleaning, if fixedly mounted to the bottom side annular peripheral flange 50, the removal of the generally cylindrical liner element 84 for replacement or cleaning would be performed in conjunction with a similar undertaking with respect to the filter element 72. Conversely, if fixedly mounted to the ledge 88, the generally cylindrical liner element 84 would rarely be a suitable candidate for removable and would be readily cleanable only when the filter element 72 is removed for either replacement or cleaning.

Still another alternate configuration of the generally cylindrical liner element 84′ is illustrated in FIGS. 4 and 5. Here, the generally cylindrical liner element 84′ is fixedly attached to the inner side surface 86a of the side wall 86 of the cylinder 14. Again, it is contemplated that the cylindrical liner element 84′ may be fixedly attached to the interior side surface 86a of the side wall 86 of the canister 14 in a variety of techniques. For example, the cylindrical liner element 84′ may be fixedly attached to the canister 14 by applying the cylindrical liner element 84′ to the canister 14 by coating the interior side surface 86a. Alternately, the cylindrical liner element 84′ may be comprised of a strip of adhesive material suitable for affixment to the interior side 86a. For both of these configurations, the cylindrical liner element 84′ would be constructed of a material to which contaminants or other particulate matter flowing through the annular outer flow area would adhere thereto upon physical contact therewith.

Regardless of which of the multitude of alternate configurations of the cylindrical liner element 84 or 84′ disclosed herein are inserted within the annular outer flow area 74, when diesel oil (or another fluid) flows into the annular outer flow area 74, all of the disclosed alternate configurations would remove a portion of any contaminants or other particulate matter carried by the diesel oil. Of course, depending on the particular configuration of the cylindrical liner element 84 or 84′ selected, the contaminants or other particulate matter removed from the diesel oil would either be trapped within the interior of the cylindrical liner element 84 or 84′ (if a screen or other meshed-type of cylindrical liner element 84 or 84′ is employed) or captured on an outer side surface of the cylindrical liner element 84 or 84′ (if an adhesive-type of cylindrical liner element 84 or 84′ is employed). Once trapped or otherwise captured by the cylindrical liner element 84 or 84′, the subject contaminants or other particulate matter may be removed from the diesel oil or other fluid during a subsequent cleaning or replacement of the cylindrical liner element 84 or 84′.

It should be noted, however, that regardless of the particular type of cylindrical liner element 84 or 84′ employed within the annular outer flow area 74 to trap or otherwise capture contaminants or other particulate matter carried by the diesel oil, the diesel oil or other fluid carrying such contaminants or other particulate matter must be directed towards the interior side surface 86a of the side wall 86 in order for the cylindrical liner element 84 or 84′ to trap or otherwise capture such contaminants or other particulate matter. Accordingly, the cylindrical liner element 84 or 84′ performs best when installed in a fluid filtration apparatus which employs centrifugal force to swirl the fluid around the inside of the canister 14 in the manner illustrated and described with respect to FIGS. 4 and 5. It should be further noted, however, that the cylindrical liner element 84 or 84′ would continue to function in the manner described and illustrated herein if used in a filter that directs incoming fluid against the side wall 86 of the canister 14 in a vertical fashion. Under such conditions, however, the effectiveness of the cylindrical liner element 84 or 84′ would be reduced.

Although an illustrative embodiment of the invention has been shown and described, other modifications, changes, and substitutions are intended in the foregoing disclosure. Accordingly, it is appropriate that the appended claims be construed broadly and in a manner consistent with the scope of the invention.

What is claimed is:

1. Fluid filtration apparatus comprising:
a housing structure having an internal flow path through which a fluid to be filtered may be flowed, said housing structure including a side wall having an interior side surface;
a filtration structure operably interposed in said internal flow path; and
a liner element disposed between said interior side surface of said side wall of said housing structure and said filtration structure operably interposed in said internal flow path.
